(19) United States
(12) Patent Application Publication
(10) Pub. No.: US 2005/0021791 A1
(43) Pub. Date: Jan. 27, 2005

(54) Communication gateway apparatus, communication gateway method, and program product

(76) Inventors: Nobuo Sakiyama, Kawasaki-shi (JP); Hideki Yoshida, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/808,564

(22) Filed: Mar. 25, 2004

(30) Foreign Application Priority Data
Mar. 31, 2003 (JP) 2003-096946
Nov. 28, 2003 (JP) 2003-400724

(51) Int. Cl. G06F 15/16; G06F 15/173

(52) U.S. Cl. 709/229; 709/202; 709/225

(57) ABSTRACT

When a proxy server receives contents transferred from a Web server to a Web browser, the proxy server extracts from the contents a script program having a function of sending cookie information stored in the Web browser from a client computer to an external transmission destination. When the script program is received, the proxy server determines whether transfer of the contents to the client computer is permitted, and only when transfer is permitted, transfers the contents to the client computer.

### CROSS-REFERENCE TO RELATED APPLICATIONS

This application is based upon and claims the benefit of priority from prior Japanese Patent Applications No. 2003-96946, filed Mar. 31, 2003; and No. 2003-400724, filed Nov. 28, 2003, the entire contents of both of which are incorporated herein by reference.

### BACKGROUND OF THE INVENTION

1. Field of the Invention

The present invention relates to a communication gateway apparatus, communication gateway method, and a computer program product for affording security of communications between a server and a client.

2. Description of the Related Art

An HTTP protocol used for Web access in the Internet is a simple protocol which is completed by sending back contents in response to a request. The HTTP protocol does not have any state across a plurality of requests. The Web server may not distinguish Web browsers by the HTTP protocol. In actual applications, Web browsers may be distinguished and authenticated, or a session which holds a state across a plurality of HTTP protocols may be maintained. For this purpose, a mechanism called a cookie has been adopted.

The cookie is a character string which can be arbitrarily interpreted by a Web server. The cookie is transmitted from a Web server in response to an HTTP request from a Web browser, and set in the Web browser. When the Web browser requests contents next time of the same Web server or a Web server belonging to the same domain, a cookie is embedded in the request and transmitted to the Web server. The Web server sends back a different cookie setting in response to a request in which no cookie is embedded. This allows the Web server to distinguish Web browsers.

As a technique of describing a document displayed on a Web browser, a program described in a script language such as JavaScript™ or VBScript™ is often embedded in an HTML document. An HTML document received by a Web browser is internally analyzed for display and processed as an object having a structure. The object undergoes event-driven operation in the script language, dynamically displaying contents. Script programs are provided by a Web server and executed on Web browsers under different managements. Objects which can be operated in a normal state are limited to display contents and GUI components of a Web browser. The above-described cookie is set by a Web server, and is so defined as to be freely operated from a script program. Operation of a cookie by a script program allows mounting even single sign-on in which a cookie character string is transferred to an affiliated site of another domain and the user of a Web browser need not perform new authentication procedure.

When the owners of a Web browser and Web server have a special relationship and the Web server is determined to be “reliable”, operation to a resource in a client computer outside the Web browser can be permitted by a script program from a specific Web server in accordance with the settings of the Web browser.

As a threat against security in this technical background, a problem called cross-site scripting vulnerability is known (see, e.g., “Secure Programming Lecture A. WEB Programmer Course”, IT Security Center of Information-technology Promotion Agency, 2001). Cross-site scripting is to mix a malicious script program in a Web page browsed by the user and to execute the script program in the Web browser of the user, damaging security such that the cookie of the Web browser leaks to an attacker server. A Web system in which such attack becomes effective has cross-site scripting vulnerability.

The cause of cross-site scripting vulnerability is that contents input from the user are not satisfactorily checked in dynamic page generation on a Web site. As a measure, contents are checked to completely disable a malicious script (see, e.g., “Secure Programming Lecture A. WEB Programmer Course”, IT Security Center of Information-technology Promotion Agency, 2001).

However, it is difficult for an average Web site builder to take such measure (see, e.g., Hiromitsu Takagi, Satoshi Sekiguchi, Kazuhito Ohmaki, “A Case Study in How E-commerce Sites Are vulnerable To the ‘Cross-Site Scripting’ Attack”, 4th Computer Security Symposium of Information Processing Society of Japan, 2001). When an application and middleware used to build a Web site are vulnerable and a site is operated by only combining and setting them, the site builder hardly has any technique of checking vulnerability. Also, when all programs which build a Web site are to be inspected, many items may be inspected.

A typical security protection device for a computer which is connected to the Internet is a firewall. However, cross-site scripting is an attack by data which is formally authentic in the HTTP protocol, and may not be prevented by a firewall for protecting a Web server.

As a more advanced protection method, an intrusion detection system is installed to finely inspect HTTP request contents (see, e.g., Abstracting Application-Level Web Security, David Scott and Richard Sharp, the 11th International World-Wide Web conference (WWW2002), 2002). Cross-site scripting vulnerability is not only the vulnerability of Web servers, most of which are implemented in a small number of computers, but also related to a wide range of middleware for which many vendors provide different implementations, and Web applications created for individual sites. A vendor which is not involved in operation of an individual site may not provide a completely effective rule set. Also, the definition of an exhaustive inspection rule costs an individual site as much as removal of vulnerability itself.

As a self-defense means, the user may inhibit execution of all script programs on a Web browser. This method inhibits even execution of authentic script programs on a Web site. In addition, cross-site scripting vulnerability is caused by a defect in Web site operation, and may not be improved.

Damages by cross-site scripting are not only leakage of a cookie, but also unexpected discard of a cookie, destruction and leakage of a file in a client computer when the Web server is set as a “reliable site”, and display of false contents. Of these damages, a cookie is utilized for session holding and authentication in many e-commerce sites. Cookie leakage directly leads to leakage of personal information of a customer and pecuniary loss by illegal business transactions. Hence, it is effective to take a measure by giving attention to cookie leakage.

When attention is given to cookie leakage, sending of a cookie is prevented by a firewall formed by software in a client computer (see, e.g., a press release by Symantec, Sep. 18, 2001, www.symantec.co.jp/region/jp/news/year01/010918.html, Symantec). However, this method inhibits execution of authentic script programs on a Web site. Further, cross-site scripting vulnerability is caused by a defect in Web site operation, and may not be improved.

As a measure against cookie leakage in both a Web site and Web browser, the Web server sets an HTTP-only attribute in a cookie, and the Web browser inhibits a script program from processing the cookie with the HTTP-only attribute (see, e.g., Mitigating Cross-site Scripting With HTTP-only Cookies, Microsoft, 2002 msdn.microsoft.com/workshop/author/dhtml/httponly_cookies.asp). However, this method assumes update of a Web browser by the user, and may not be utilized when a cookie is operated by a script for a justifiable reason.

By using cross-site scripting vulnerability, secret information can be leaked between computes other than a server and client on a Web page. Further, secret information can be defrauded by prompting the user to input it by illicitly changing the transmission destination of an input form in a Web page, displaying a Web page having another input form instead of the Web page of an authentic site, or displaying a Web page having another input form in the Web page of an authentic site using an internal frame.

Leakage of information such as a cookie stored in a Web browser by misusing cross-site scripting vulnerability is directly linked to leakage of personal information of a customer and pecuniary loss by illegal business transactions. However, it is difficult for a Web site administrator who should have a responsibility to inspect and remove all vulnerability in advance. It is also as difficult as complete removal of vulnerability from a Web application to fully take a measure without impairing the usability of Web scripting by an existing vulnerability prevention technique. Leakage of information from a Web page and defraudation of a user form input by misusing cross-site scripting vulnerability are also directly linked to leakage of personal information of a customer and pecuniary loss by illegal business transactions.

### BRIEF SUMMARY OF THE INVENTION

It is an object of the present invention to provide a communication gateway apparatus, communication gateway method, and program product capable of preventing an attack utilizing a malicious script contained in contents transferred from a server to a client.

According to embodiments of the present invention, there is provided a communication gateway apparatus, method and computer program product for affording security of communication between a vulnerable server and a client. First, a content transferred from the vulnerable server is received and a script program is extracted from the received content. The script program is then inspected to identify a transfer destination of information. Transferring the information is caused by the client executing the script program. The identified transfer destination of the information is collated with a permitted transfer destination list, and the received content to the client is transmit only if the identified transfer destination of the information is within the permitted transfer destination list, so as to prevent the information from illicitly transferring to a malicious server.

### BRIEF DESCRIPTION OF THE SEVERAL VIEWS OF THE DRAWING

FIG. 1 is a view showing an example of the configuration of a communication system according to the first embodiment of the present invention;

FIG. 2 is a block diagram showing an example of the configuration of a communication gateway apparatus according to the first embodiment;

FIG. 3 is a view showing an example of a transfer permission list;

FIG. 4 is a view for explaining a typical use case of a cookie;

FIG. 5 is a view for explaining an example of cookie transfer to an affiliated site;

FIG. 6 is a view for explaining cookie leakage due to cross-site scripting vulnerability and avoidance of cookie leakage by cutting off malicious contents by the communication gateway apparatus according to the first embodiment;

FIG. 7 is a flowchart showing an example of the processing sequence of a communication control apparatus according to the first and second embodiments of the present invention;

FIG. 8 is a flowchart showing an example of the processing sequence of the communication control apparatus according to the first embodiment of the present invention;

FIG. 9 is a block diagram showing an example of the configuration of a communication gateway apparatus according to the second embodiment of the present invention;

FIG. 10 is a view for explaining content information leakage due to cross-site scripting vulnerability and avoidance of content leakage by cutting off malicious contents by the communication gateway apparatus according to the second embodiment;

FIG. 11 is a view for explaining information defraudation by changing a form transmission destination due to cross-site scripting vulnerability and avoidance of information defraudation by cutting off malicious contents by the communication gateway apparatus according to the second embodiment;

FIG. 12 is a view for explaining input defraudation by displaying a false form using redirection due to cross-site scripting vulnerability and avoidance of input defraudation by cutting off malicious contents by the communication gateway apparatus according to the second embodiment;

FIG. 13 is a view for explaining information defraudation by displaying a false form due to cross-site scripting vulnerability and avoidance of information defraudation by cutting off malicious contents by the communication gateway apparatus according to the second embodiment;

FIG. 14 is a view for explaining form input defraudation by adding a false form due to cross-site scripting vulnerability and avoidance of information defraudation by cutting off malicious contents by the communication gateway apparatus according to the second embodiment; and

FIGS. 15 and 16 are flowcharts showing an example of the processing sequence of the communication control apparatus according to the second embodiment.

### DETAILED DESCRIPTION OF THE INVENTION

Embodiments of the present invention will be described in detail below with reference to the several views of the accompanying drawing.

In the following description, a communication gateway apparatus takes a proxy server form in which a network side communication interface and Web server side communication interface function as communication end points and transfer communication contents.

(First Embodiment)

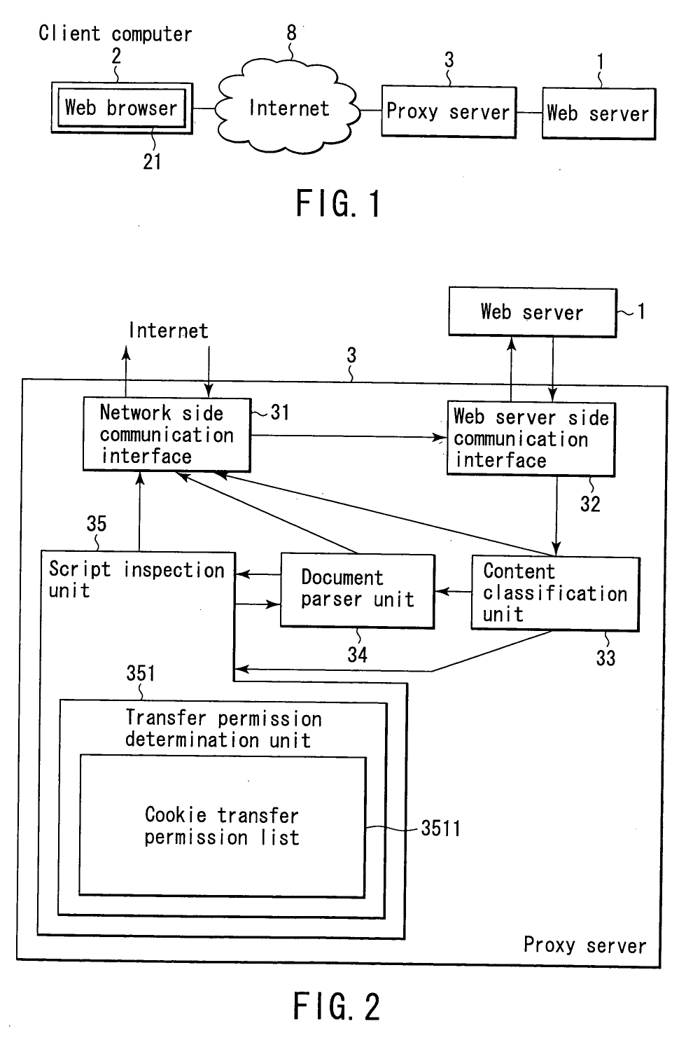

FIG. 1 shows an example of the configuration of a communication system according to the first embodiment of the present invention. In FIG. 1, reference numeral 1 denotes a Web server; 2, a client computer; 21, a Web browser which runs on the client computer 2; 3, a proxy server (communication gateway apparatus); and 8, a network (in this embodiment, the Internet).

Only one Web server is illustrated in FIG. 1, but a plurality of Web servers can exist. Similarly, a plurality of client computers 2 can exist.

As for the correspondence between the proxy server 3 and the Web server 1, one proxy server 3 can target one Web server 1, or one proxy server 3 can target a plurality of Web servers 1.

FIG. 2 shows an example of the configuration of the proxy server according to the first embodiment.

As shown in FIG. 2, the proxy server 3 comprises a network side communication interface 31 which communicates with a Web browser (running in the requesting client computer 2), a Web server side communication interface 32 which communicates with the Web server 1, a content classification unit 33, a document parser unit 34, and a script inspection unit 35.

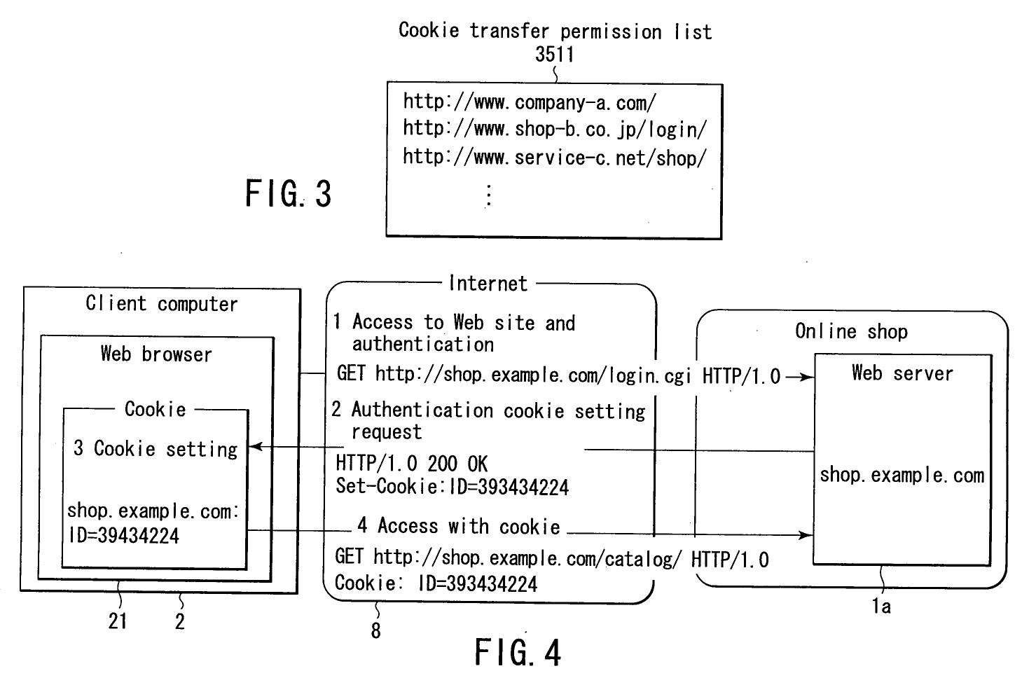

The script inspection unit 35 has a transfer permission determination unit 351, and the transfer permission determination unit 351 has a transfer permission list 3511. FIG. 3 shows an example of the transfer permission list 3511.

The Web server 1 and proxy server 3 are directly connected in FIG. 1, but may be connected via an intranet or the Internet (in the latter case, security is preferably ensured by encrypted communication or the like). The proxy server 3 and network 8 are directly connected in FIG. 1, but may be connected via another gateway apparatus connectable through an intranet.

The proxy server can be implemented by, e.g., a computer.

The outline of the operation according to the first embodiment will be described.

The Web browser (see the client computer 2 in FIG. 1) is connected to the network side communication interface 31 by TCP/IP, and transmits an HTTP request. The request received by the network side communication interface 31 of the proxy server 3 is directly sent to the Web server 1 via the Web server side communication interface 32. The Web server 1 transmits a response corresponding to the request to the Web server side communication interface 32 of the proxy server 3. The Web server side communication interface 32 of the proxy server 3 sends contents to the content classification unit 33. In accordance with the data type, the content classification unit 33 classifies the content into a document of type which may contain a script and data which do not contain any script. The content classification unit 33 sends back the data which do not contain any script to the Web browser via the network side communication interface 31. The content classification unit 33 sends the document of type which may contain a script to the document parser unit 34 corresponding to each data type. When the document itself is a script, the content classification unit 33 sends the document to the script inspection unit 35.

The document parser unit 34 of the proxy server 3 analyzes the syntax of the document. When the document does not contain any script as a result of syntax analysis, the document parser unit 34 sends back the document to the Web browser via the network side communication interface 31. When the document contains a script, the document parser unit 34 sends the document to the script inspection unit 35. The script inspection unit 35 inspects the script for the presence of a program which tries to transfer any data depending on information stored in the Web browser. If transfer may be done, the transfer permission determination unit 351 determines whether transfer is permitted. In this case, the transfer permission determination unit 351 performs collation using, as a transfer permission rule, the transfer permission list 3511 which holds a list of transfer destinations as URLs. When transfer which is not permitted is contained, the script inspection unit 35 transmits an error to the Web browser via the network side communication interface 31. The script inspection unit 35 inspects whether a document is dynamically generated by the script, and if so, sends the result to the document parser unit 34 and performs inspection again. Only when transfer which is not permitted is not contained, the script inspection unit 35 sends back a response from the Web server 1 to the Web browser via the network side communication interface 31.

Prior to a description of a more detailed operation example according to the first embodiment, cookie leakage due to cross-site scripting vulnerability will be explained.

A cookie will be considered as an example of information stored in the Web browser.

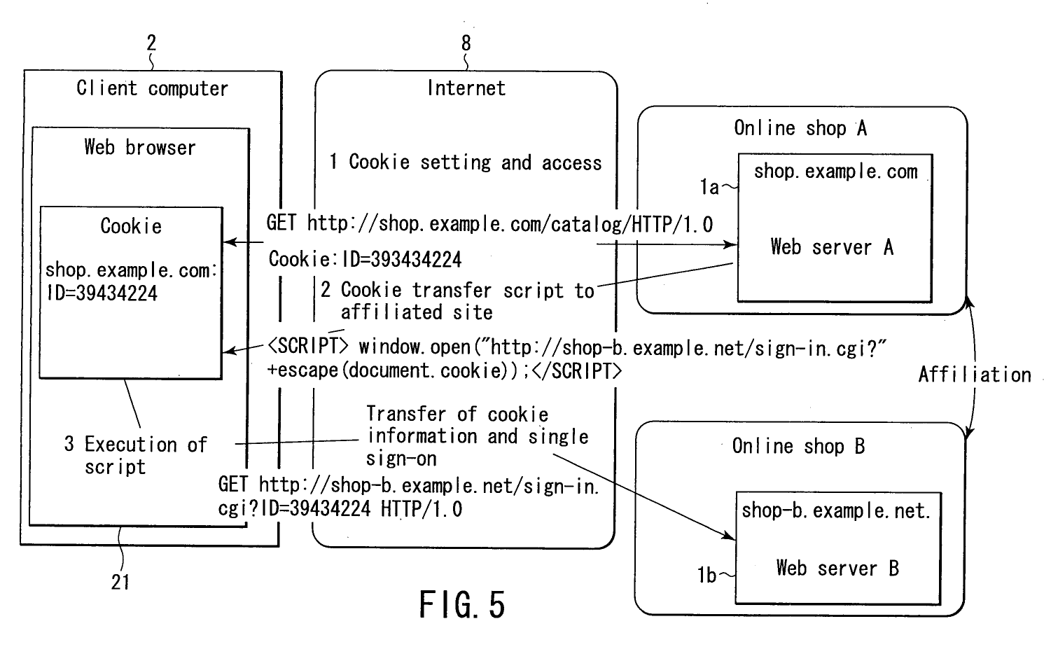

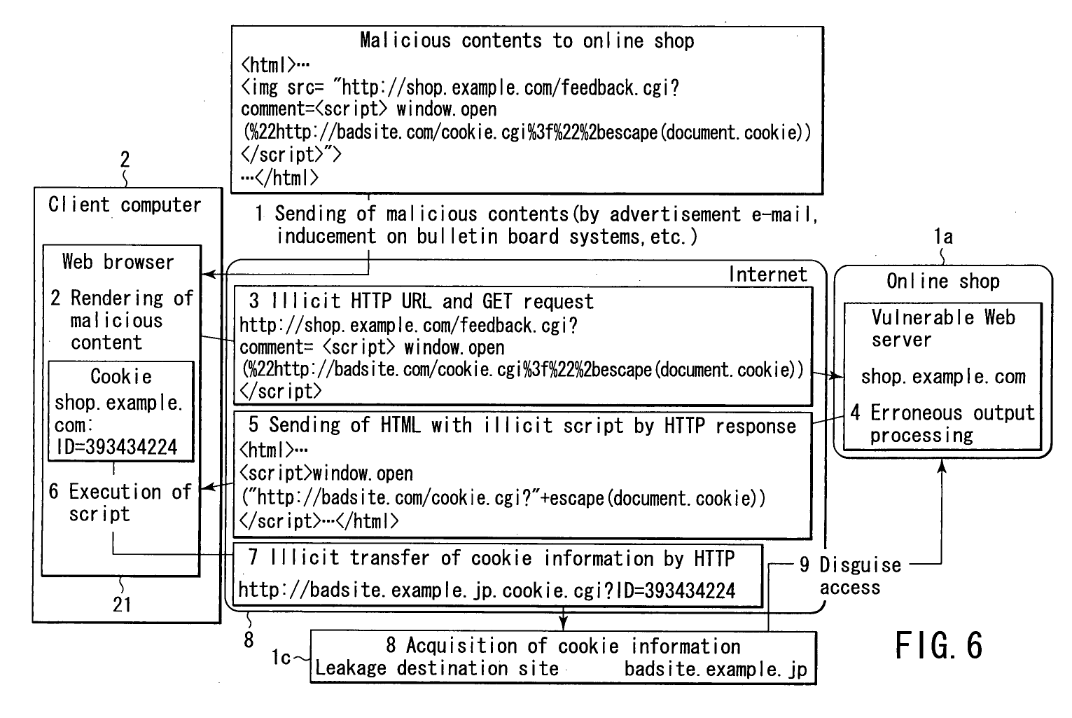

A typical use case of the cookie will be explained with reference to FIG. 4. FIG. 4 shows a case in which transfer is permitted by the proxy server. FIG. 4 does not illustrate the proxy server. FIG. 4 shows an online shop as an example of a Web site (this also applies to FIGS. 5 and 6 to be described later).
(1) A client computer performs access and authentication to a desired Web server.
(2) The Web server issues an authentication cookie setting request to the client computer.
(3) The client computer sets a cookie.
(4) The client computer accesses the Web server with the cookie.

Accordingly, the Web server can provide a server which requires identification of a Web browser.

An example of transferring a cookie to an affiliated site will be explained with reference to FIG. 5. FIG. 5 shows a case in which the proxy server permits transfer. FIG. 5 does not illustrate the proxy server.
(1) Procedures (1) to (4) in FIG. 4 are executed between a client computer and a Web server A.
(2) The Web server A transmits a “cookie transfer script to an affiliated site B” to the client computer.
(3) The client computer executes a “cookie transfer script to an affiliated site B”. The executed script performs cookie information transfer/single sign-on from the client computer to a Web server B.

In this way, operation of a cookie by a script program allows transferring cookie information to anther Web server and achieving, e.g., single sign-on in which the user of the Web browser need not perform new authentication procedure.

An example of cookie leakage due to cross-site scripting vulnerability will be explained with reference to FIG. 6.

In cross-site scripting, the misuse of the mechanism as shown in FIG. 5 may allow illicit operation such that a malicious script program is mixed in a Web page browsed by the user and executed in the Web browser of the user to leak cookie information of the Web browser to an attacker server. In addition to leakage of cookie information, destruction and leakage of a file in a client computer and display of false contents may also occur. For example, such illicit operation is realized as follows.

A Web server (1a) in FIG. 6 has vulnerability (note that the Web server itself is authentic). Assume that the client computer has already performed, e.g., the sequence in FIG. 4 with the Web server having the vulnerability, and sets a cookie.
(1) An attacker sends malicious contents to a client computer. This is done by various methods such as advertisement e-mail and an inducement on a Web-based bulletin board system.
(2) The Web browser of the client computer renders the malicious contents.
(3) The client computer sends to the Web server a GET request containing illicit data such as original data of a cookie transfer script to, e.g., a leakage destination site.
(4) The Web server which has received the GET request executes erroneous output processing.
(5) As a result, the Web server sends an HTML document with the malicious script (cookie transfer script to the leakage destination site).
(6) The Web browser of the client computer which has received the HTML document with the malicious script (cookie transfer script to the leakage destination site) executes the malicious script, i.e., the cookie transfer script to the leakage destination site.
(7) As a result, the client computer illicitly transfers cookie information to the leakage destination site.
(8) The leakage destination site (1c) can illicitly acquire cookie information of the attacked client computer.
(9) The leakage destination site disguises itself as, e.g., the attacked client computer, and can access the Web server.

To prevent this, the first embodiment cuts off an HTML document with a malicious script in (5) of FIG. 6 by the proxy server interposed between the Web server and the Internet in FIG. 6. This can prevent leakage of cookie information or the like.

A more detailed operation example according to the first embodiment will be explained.

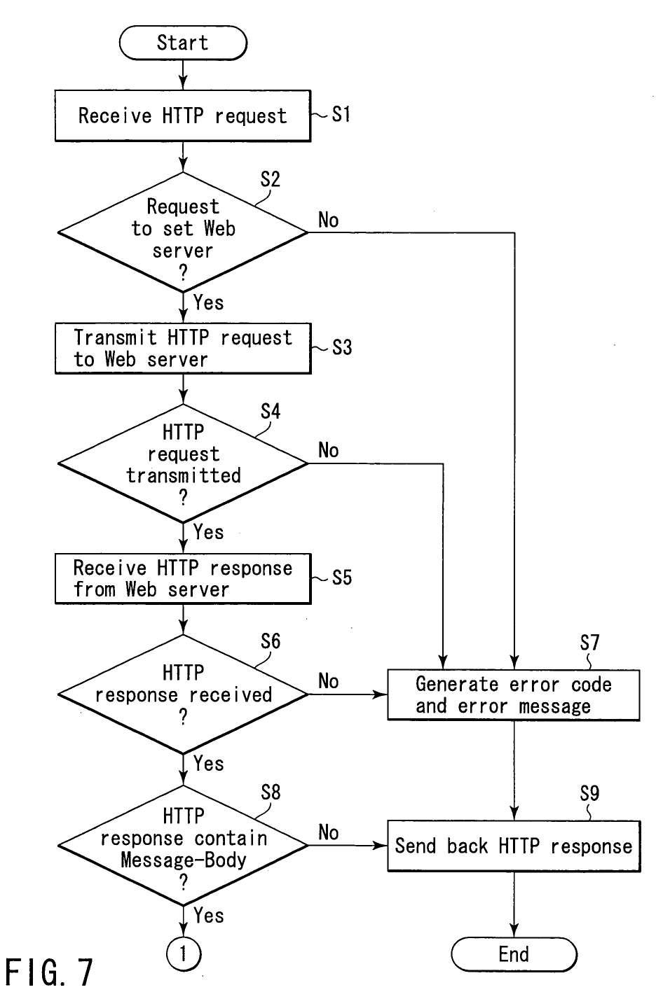

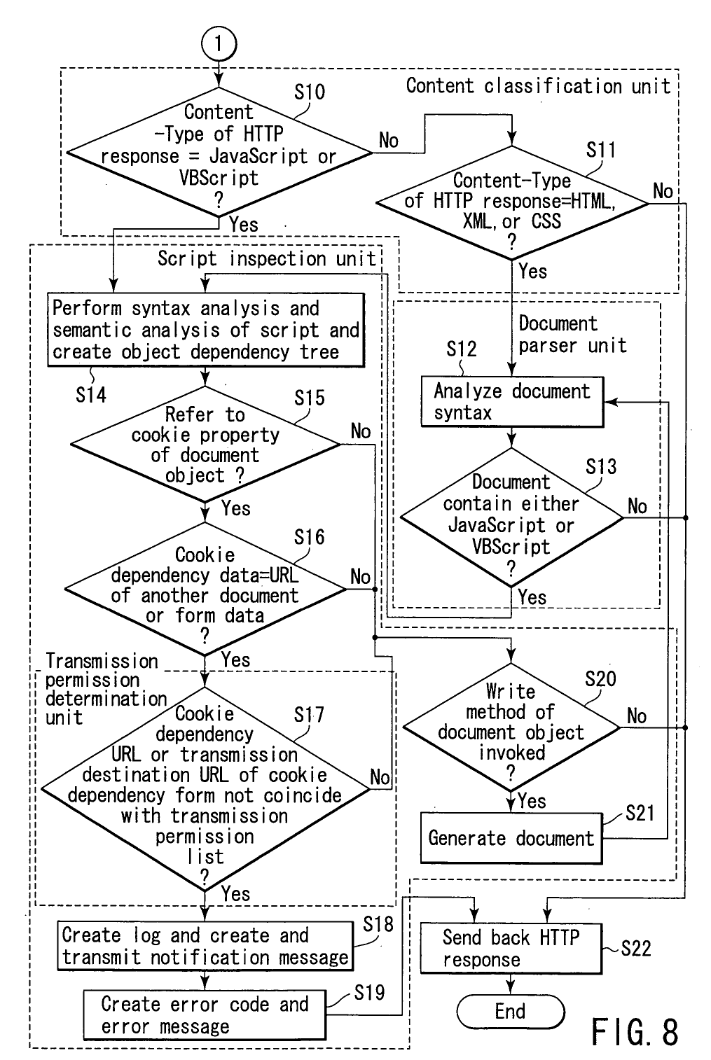

FIGS. 7 and 8 show an example of the processing sequence of the proxy server 3 according to the first embodiment.

For example, JavaScript and VBScript are targeted as scripts, and HTML, XML, and CSS are targeted as documents which may contain scripts. As described above, an example of information stored in a Web browser is a cookie.

A request from the Web browser (see the client computer 2 in FIG. 1) is sent to the Web server 1 via the proxy server 3, and a response from the Web server 1 is received by the proxy server 3 (step S1).

Upon reception of the HTTP request, the proxy server 3 confirms that the request is a request to a set Web server (step S2), and then transmits the request to the Web server 1 (step S3), and receives an HTTP response from the corresponding Web server 1 (step S5).

If an error occurs in a series of processes (NO in step S2, S4, or S6), the proxy server 3 generates an error code and error message (step S7), and sends back a response representing the error to the Web browser (step S8).

If the received (step S5) HTTP response does not contain any HTTP Message-Body (step S8), the proxy server 3 sends back the HTTP response so as to directly transfer it to the Web browser (step S9).

The contents of the HTTP response are sent to the content classification unit 33.

The content classification unit 33 sends the contents to the script inspection unit 35 when the contents are JavaScript or VBScript depending on the Content-Type header of the HTTP response (step S10), or to the document parser unit 34 when the contents are HTML, XML, or CSS (step S11); otherwise (NO in step S10 or S11), sends back the HTTP response from the Web server 1 so as to directly transfer it to the Web browser (step S22).

The document parser unit 34 performs syntax analysis corresponding to the document type (step S12). If the document contains a JavaScript or VBScript script (step S13), the document parser unit 34 sends the document to the script inspection unit 35. If the document does not contain any script (step S13), the document parser unit 34 sends back the HTTP response from the Web server so as to directly transfer it to the Web browser (step S22).

The script inspection unit 35 performs syntax analysis and semantic analysis of the script, and creates an object dependency tree to be processed in the script (step S14).

If the Cookie property of the Document object in the dependency tree is referred to (step S15), and data depending on this cookie are the URLs and Form data of another document (step S16), the transfer permission determination unit 351 inspects whether these URLs coincide with the contents of the transfer permission list 3511. If no URL at issue can be listed even upon constant folding of the object dependency tree, transfer to an arbitrary URL is assumed and inspection is done (in this case, if transfer to an arbitrary transfer destination is not permitted, transfer is determined not to be permitted).

If even one URL which does not coincide with the permission list is determined to be used in cookie transfer (step S17), transfer of the Web contents is determined not to be permitted. Sending of the Web contents to the Web browser (client computer 2) is inhibited, and the request for the detected Web contents from the Web browser and the contents are saved. A log for notifying the Web server administrator of this is recorded. A notification message containing the log (or only the contents or request) is created and transmitted by mail to an administrator (account) set in advance (step S16). For the HTTP response, an error code and error message are generated (step S19), and sent back to the Web browser (step S22).

The script inspection unit 35 also inspects whether the write method of the Document object has been invoked, in addition to cookie inspection. A document to be interpreted by the Web browser is generated by the write method of the Document object. Thus, if the document contains a script, the script may be executed. If NO in step S15, S16, or S17 and the write method of the Document object has been invoked (step S20), a new document is created by partially executing the script (step S21). The script inspection unit 35 hands over processing to the document parser unit 34, and returns to the step of inspecting whether a script is contained.

When the script can be determined through the above inspection not to illicitly transfer a cookie, an HTTP response from the Web server is sent back so as to directly transfer it to the Web browser.

In this manner, the first embodiment can prevent leakage of cookie information or the like.

In the above description, when transfer of Web contents is determined not to be permitted, sending of the Web contents to the Web browser (client computer 2) is inhibited, and a notification message and error message are transmitted. Alternatively, either or both of transmission of a notification message and transmission of an error message may not be performed (log may not be saved).

In the above description, the transfer permission determination unit 351 uses, as a transfer permission rule, the transfer permission list 3511 which holds a list of transfer destinations as URLs, and collates a script with the transfer permission list 3511. Instead, the transfer permission determination unit 351 may hold permitted transfer destination URLs as the description of regular expressions, collate the regular expressions with respective transfer destination URLs, and only when all the transfer destination URLs coincide with the regular expressions, send back a transfer permission result. Alternatively, the transfer permission determination unit 351 may adopt these two methods.

(Second Embodiment)

An example of the configuration of a communication system according to the second embodiment of the present invention is the same as that in FIG. 1.

Only one Web server is illustrated in FIG. 1, but a plurality of Web servers can exist. Similarly, a plurality of client computers 2 can exist.

As for the correspondence between a proxy server 3 and a Web server 1, one proxy server 3 can target one Web server 1, or one proxy server 3 can target a plurality of Web servers 1.

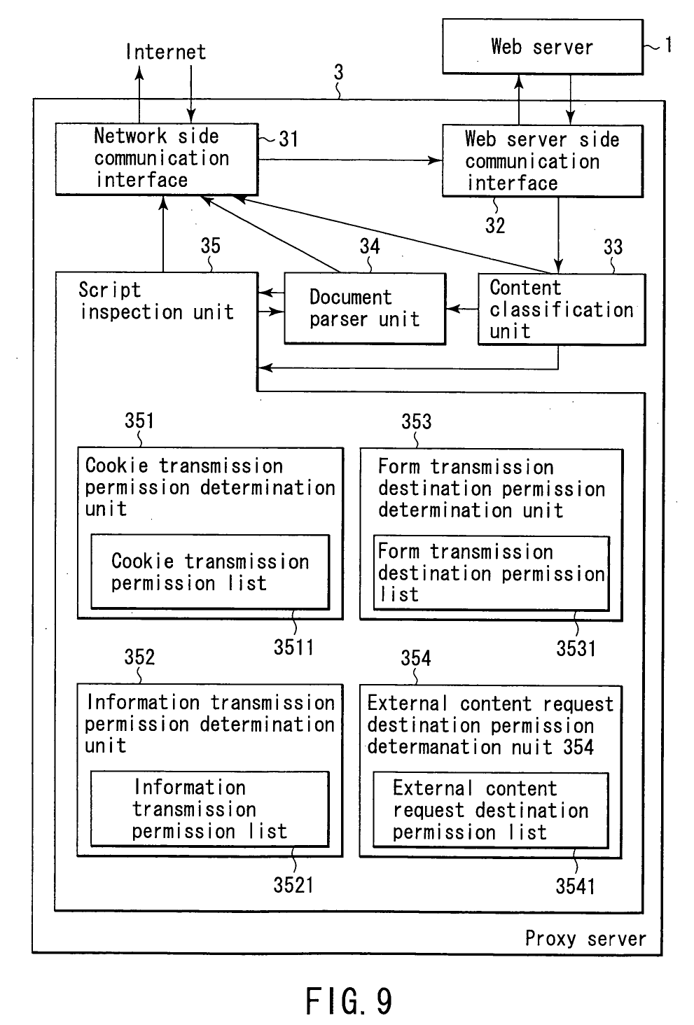

FIG. 9 shows an example of the configuration of the proxy server according to the second embodiment.

As shown in FIG. 3, the proxy server 3 comprises a network side communication interface 31 which communicates with a Web browser (running in the requesting client computer 2), a Web server side communication interface 32 which communicates with the Web server 1, a content classification unit 33, a document parser unit 34, and a script inspection unit 35.

The script inspection unit 35 has a cookie transfer permission determination unit 351, information transfer permission determination unit 352, form transmission destination permission determination unit 353, and external content request destination permission determination mechanism 354.

The cookie transfer permission determination unit 351 is basically the same as the transfer permission determination unit 351 in the first embodiment. That is, in the second embodiment, the information transfer permission determination unit 352, form transmission destination permission determination unit 353, and external content request destination permission determination mechanism 354 are added to the script inspection unit 35.

The cookie transfer permission determination unit 351 has a cookie transfer permission list 3511. The information transfer permission determination unit 352 has an information transfer destination permission list 3521. The form transmission destination permission determination unit 353 has a form transmission destination permission list 3531. The external content request destination permission determination mechanism 354 has an external content request destination permission list 3541. An example of the cookie transfer permission list 3511, an example of the information transfer destination permission list 3521, an example of the form transmission destination permission list 3531, and an example of the external content request destination permission list 3541 are the same as that shown in FIG. 3. The contents of the permission lists 3511, 3521, 3531, and 3541 can be independently set, but may be the same.

The Web server 1 and proxy server 3 are directly connected in FIG. 1, but may be connected via an intranet or the Internet (in the latter case, security is preferably ensured by encrypted communication or the like). The Web server 1 and a network 8 are directly connected in FIG. 1, but may be connected via another gateway apparatus connectable through an intranet.

The proxy server can be implemented by, e.g., a computer.

The outline of the operation according to the second embodiment will be described.

The Web browser (see the client computer 2 in FIG. 1) is connected to the network side communication interface 31 by TCP/IP, and transmits an HTTP request. The request received by the network side communication interface 31 of the proxy server 3 is directly sent to the Web server 1 via the Web server side communication interface 32. The Web server 1 transmits a response corresponding to the request to the Web server side communication interface 32 of the proxy server 3. The Web server side communication interface 32 of the proxy server 3 sends contents to the content classification unit 33. In accordance with the data type, the content classification unit 33 classifies the content into a document of type which may contain a script and data which do not contain any script. The content classification unit 33 sends back the data which do not contain any script to the Web browser via the network side communication interface 31. The content classification unit 33 sends the document of type which may contain a script to the document parser unit 34 corresponding to each data type. When the document itself is a script, the content classification unit 33 sends the document to the script inspection unit 35.

The document parser unit 34 of the proxy server 3 analyzes the syntax of the document. When the document does not contain any script as a result of syntax analysis, the document parser unit 34 sends back the document to the Web browser via the network side communication interface 31. When the document contains a script, the document parser unit 34 sends the document to the script inspection unit 35. The script inspection unit 35 inspects the script for the presence of a program which tries to transfer any data depending on information stored in the Web browser. If transfer may be done, the cookie transfer permission determination unit 351 determines whether transfer is permitted. In this case, the cookie transfer permission determination unit 351 performs collation using, as a transfer permission rule, the transfer permission list 3511 which holds a list of transfer destinations as URLs. When transfer which is not permitted is contained, the script inspection unit 35 transmits an error to the Web browser via the network side communication interface 31.

The above operation is basically the same as that in the first embodiment.

The script inspection unit 35 inspects whether the script is a program which tries to transfer information in contents. If transfer may be done, the information transfer permission determination unit 352 determines whether transfer is permitted. The information transfer permission determination unit 352 performs collation using, as a transfer permission rule, the transfer permission list 3521 which holds a list of transfer destinations as URLs. When transfer which is not permitted is contained, the script inspection unit 35 transmits an error to the Web browser via the network side communication interface 31. The script inspection unit 35 inspects whether the script is a program which tries to change a form transmission destination. If change may be done, the form transmission destination permission determination unit 353 determines whether change of the transmission destination is permitted. The form transmission destination permission determination unit 353 performs collation using, as a transmission destination permission rule, the transmission destination permission list 3531 which holds a list of transmission destinations as URLs. When change of the transmission destination that is not permitted is contained, the script inspection unit 35 transmits an error to the Web browser via the network side communication interface 31. The script inspection unit 35 inspects whether the script is a program which tries to display external contents by changing location information of an object or changing the src attribute of an iframe tag. If change may be done, the external content request destination permission determination unit 354 determines whether change of the transmission destination is permitted. The external content request destination permission determination unit 354 performs collation using, as a transmission destination permission rule, the request destination permission list 3541 which holds a list of request destinations as URLs. When change of the transmission destination that is not permitted is contained, the script inspection unit 35 transmits an error to the Web browser via the network side communication interface 31. Further, the script inspection unit 35 inspects whether a document is dynamically generated by the script, and if so, inspects whether a form or iframe tag is inserted. If a form or iframe tag is inserted, the form is determined by the form transmission destination permission determination unit 353, and iframe is determined by the external content request destination permission determination unit 354. The script inspection unit 35 sends back the document generation result to the document parser unit 34, and performs inspection again. Only when transfer, transmission, and external content request which are not permitted are not contained, the script inspection unit 35 sends back a response from the Web server 1 to the Web browser via the network side communication interface 31.

Prior to a description of a more detailed operation example according to the second embodiment, content information leakage due to cross-site scripting vulnerability, defraudation of form input by changing a form transmission destination, and defraudation of form input information by displaying a false external form will be explained.

A typical use case of the cookie (see FIG. 4), an example of cookie transfer to an affiliated site (see FIG. 5), and cookie leakage due to cross-site scripting vulnerability (see FIG. 6) are the same as those described in the first embodiment.

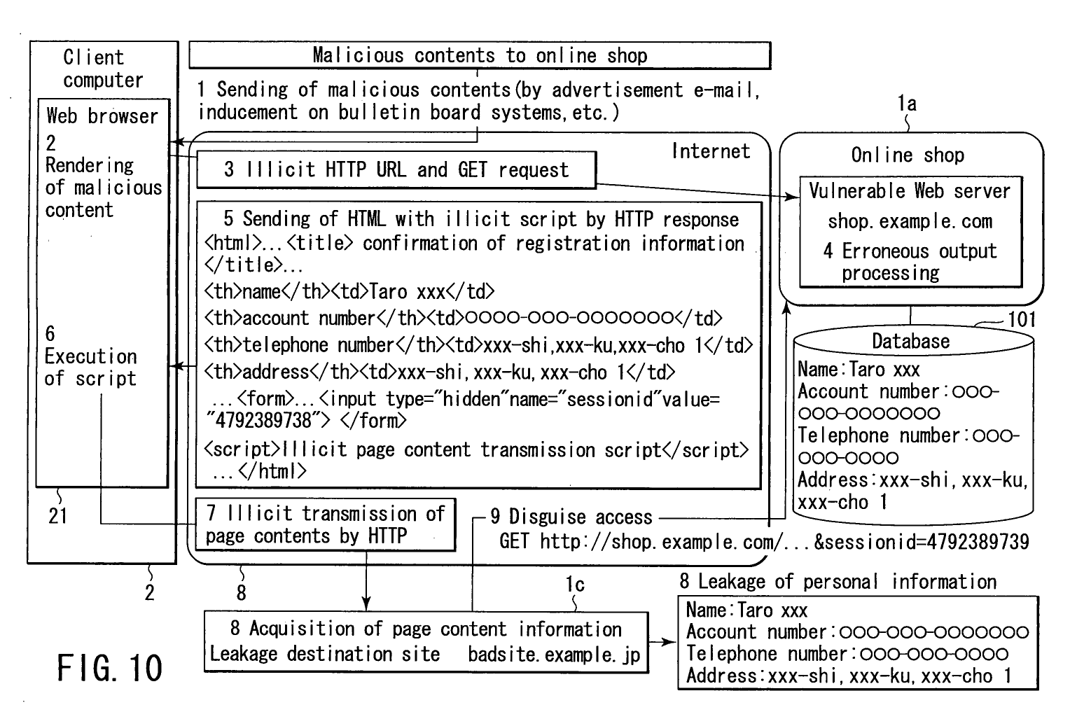

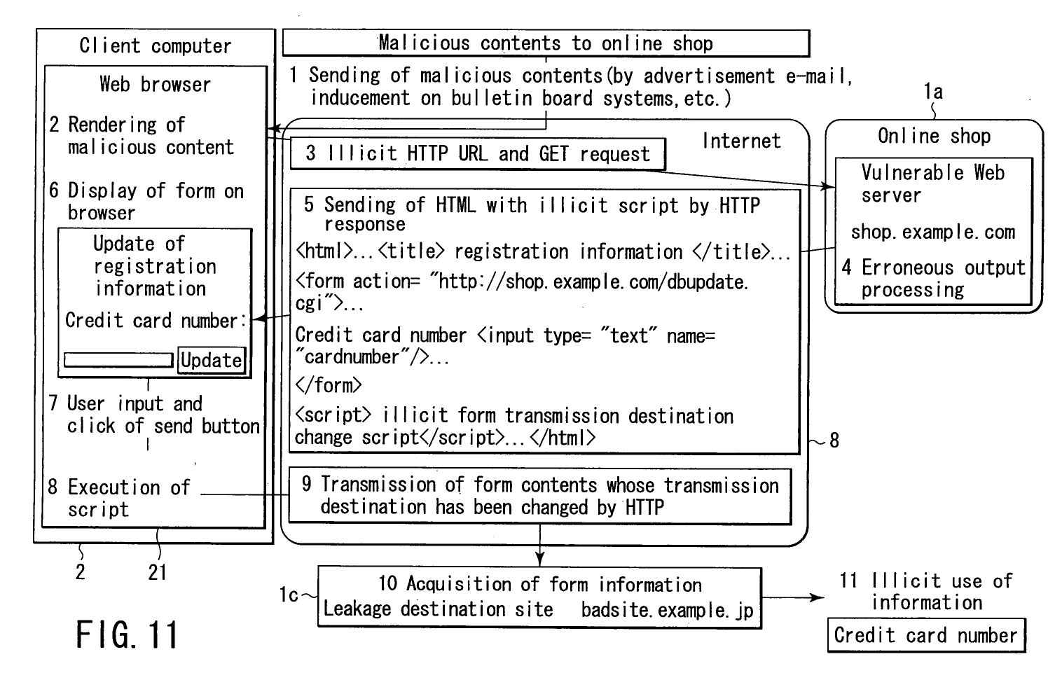

An example of content information leakage due to cross-site scripting vulnerability will be explained with reference to FIG. 10. FIG. 10 shows an online shop as an example of a Web site (this also applies to FIGS. 11, 12, 13, and 14 to be described later).

In cross-site scripting, illicit operation may be performed such that a malicious script program is mixed in a Web page browsed by the user and executed in the Web browser of the user to leak information described in contents during a session to an attacker server.

A Web server (1a) in FIG. 10 has vulnerability (note that the Web server itself is authentic).
(1) An attacker sends malicious contents to a client computer. This is done by various methods such as advertisement e-mail and an inducement on a Web-based bulletin board system.
(2) The Web browser of the client computer renders the malicious contents.
(3) The client computer sends to the Web server a GET request containing illicit data such as original data of a content information transfer script to, e.g., a leakage destination site.
(4) The Web server which has received the GET request executes erroneous output processing.
(5) As a result, the Web server sends an HTML document with the malicious script (content information transfer script to the leakage destination site).
(6) The Web browser of the client computer which has received the HTML document with the malicious script (content information transfer script to the leakage destination site) executes the malicious script, i.e., the content information transfer script to the leakage destination site.
(7) As a result, the client computer illicitly transfers content information to the leakage destination site. If the content information contains, e.g., secret information from a database 101, the secret information is leaked.
(8) The leakage destination site (1c) can illicitly acquire information unique to the attacked client computer or the user.
(9) The leakage destination site disguises itself as, e.g., the attacked client computer, can access the Web server, and can divert another acquired information.

An example of form input defraudation by changing a form transmission destination due to cross-site scripting vulnerability will be explained with reference to FIG. 11.

In cross-site scripting, illicit operation may be performed such that a malicious script program is mixed in a Web page browsed by the user and executed in the Web browser of the user to defraud a form input by changing a form transmission destination.

A Web server (1a) in FIG. 11 has vulnerability (note that the Web server itself is authentic).
(1) An attacker sends malicious contents to a client computer. This is done by various methods such as advertisement e-mail and an inducement on a Web-based bulletin board system.
(2) The Web browser of the client computer renders the malicious contents.
(3) The client computer sends to the Web server a GET request containing illicit data such as original data of an illicit form transmission destination change script.
(4) The Web server which has received the GET request executes erroneous output processing.
(5) As a result, the Web server sends an HTML document with the malicious script (illicit form transmission destination change script to the leakage destination site).
(6) The Web browser of the client computer normally displays a form.
(7) The user inputs information in the form displayed on the Web browser, and performs transmission operation.
(8) In response to transmission operation, the Web browser of the client computer executes the malicious script, i.e., the form transmission destination change script to the leakage destination site, and then transmits the information.
(9) As a result, the client computer illicitly transfers the form input information to the leakage destination site.
(10) The leakage destination site (1c) can illicitly acquire information unique to the user.
(11) The leakage destination site can divert, e.g., the acquired information unique to the user.

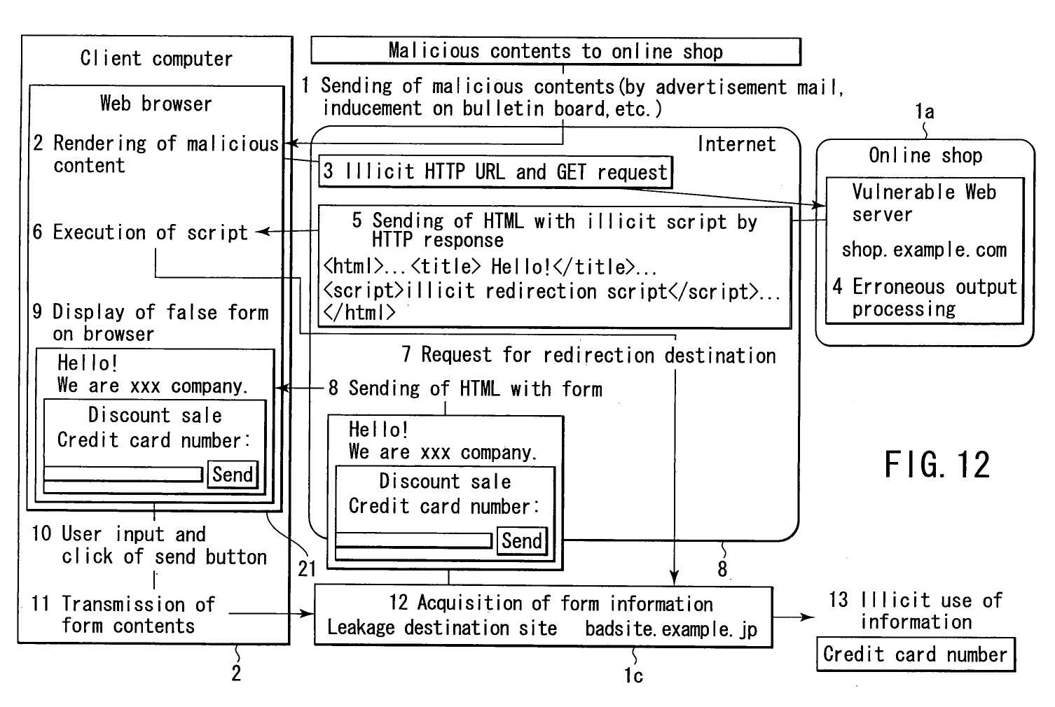

An example of input defraudation by displaying a false form using redirection due to cross-site scripting vulnerability will be explained with reference to FIG. 12.

In cross-site scripting, illicit operation may be performed such that a malicious script program is mixed in a Web page browsed by the user and executed in the Web browser of the user to defraud form input information by displaying a false external form.

A Web server (1a) in FIG. 12 has vulnerability (note that the Web server itself is authentic).
(1) An attacker sends malicious contents to a client computer. This is done by various methods such as advertisement e-mail and an inducement on a Web-based bulletin board system.
(2) The Web browser of the client computer renders the malicious contents.
(3) The client computer sends to the Web server a GET request containing illicit data such as original data of a false external form display script.
(4) The Web server which has received the GET request executes erroneous output processing.
(5) As a result, the Web server sends an HTML document with the malicious script (false external form output script).
(6) The Web browser of the client computer executes the illicit redirection script.
(7) The Web browser of the client computer transmits the request of the illicit redirection destination to a designated server, in this case, the leakage destination site.
(8) The leakage destination site sends HTML contents containing a form. The form transmission destination is the leakage destination site.
(9) The Web browser of the client computer displays the form sent from the leakage destination site, i.e., the false form together with contents similar to contents from the Web server (1a).
(10) The user inputs information in the false form displayed on the Web browser, and performs transmission operation.
(11) In response to transmission operation by the user, the Web browser of the client computer transmits the information input to the false form to the leakage destination site.

Consequently, the client computer illicitly transfers the form input information to the leakage destination site.
(12) The leakage destination site (1c) can illicitly acquire information unique to the user.
(13) The leakage destination site can divert, e.g., the acquired information unique to the user.

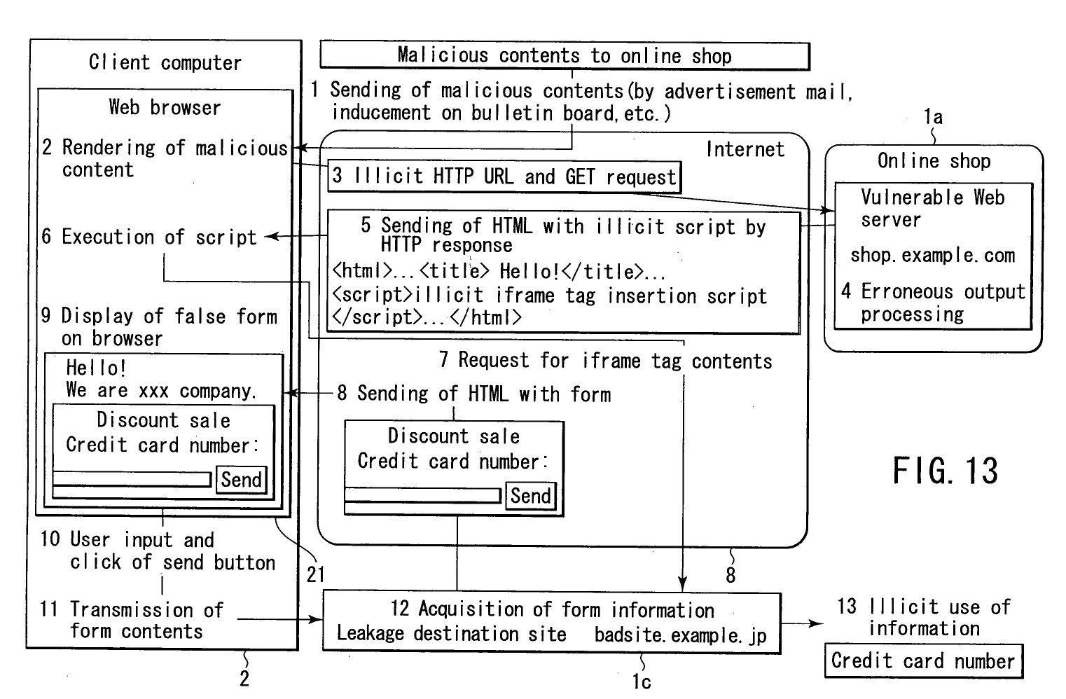

An example of form input defraudation by displaying a false external form due to cross-site scripting vulnerability will be explained with reference to FIG. 13.

In cross-site scripting, illicit operation may be performed such that a malicious script program is mixed in a Web page browsed by the user and executed in the Web browser of the user to defraud form input information by displaying a false external form.

A Web server (1a) in FIG. 13 has vulnerability (note that the Web server itself is authentic).
(1) An attacker sends malicious contents to a client computer. This is done by various methods such as advertisement e-mail and an inducement on a Web-based bulletin board system.
(2) The Web browser of the client computer renders the malicious contents.
(3) The client computer sends to the Web server a GET request containing illicit data such as original data of a false external form display script.
(4) The Web server which has received the GET request executes erroneous output processing.
(5) As a result, the Web server sends an HTML document with the malicious script (false external form display script).
(6) The Web browser of the client computer executes the malicious script, and processes an illicitly inserted iframe tag.
(7) The Web browser of the client computer transmits a request in the iframe tag to a designated server, in this case, the leakage destination site in order to display the iframe tag.
(8) The leakage destination site sends HTML contents containing a form. The form transmission destination is the leakage destination site.
(9) The Web browser of the client computer displays the form sent from the leakage destination site, i.e., the false form together with authentic contents.
(10) The user inputs information in the false form displayed on the Web browser, and performs transmission operation.
(11) In response to transmission operation by the user, the Web browser of the client computer transmits the information input to the false form to the leakage destination site.

As a result, the client computer illicitly transfers the form input information to the leakage destination site.
(12) The leakage destination site (1c) can illicitly acquire information unique to the user.
(13) The leakage destination site can divert, e.g., the acquired information unique to the user.

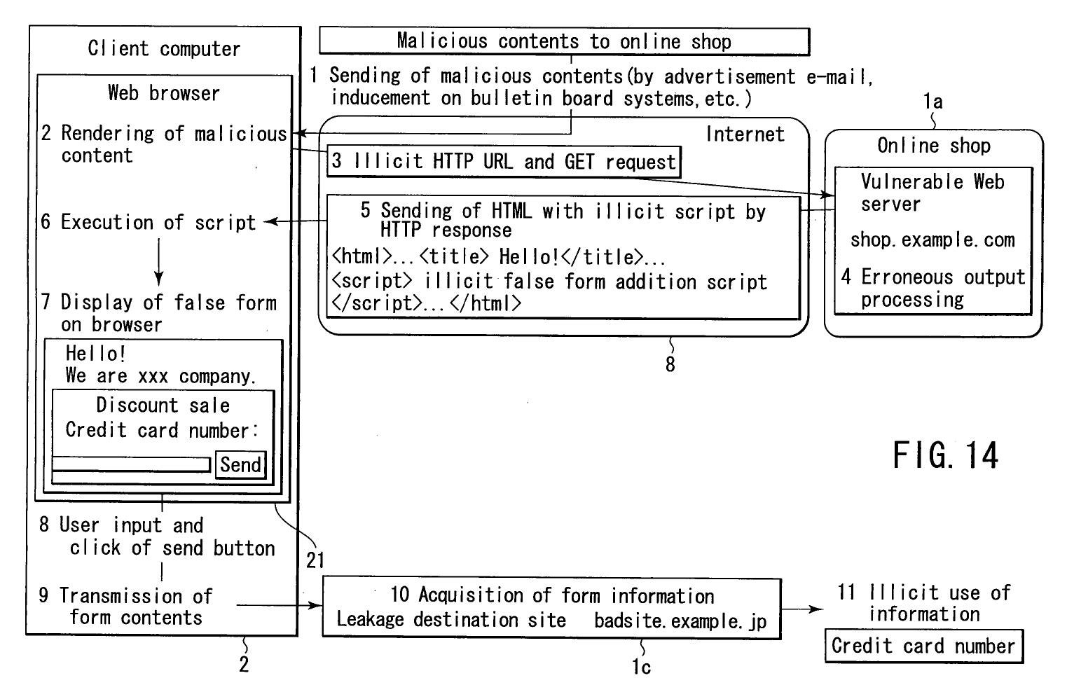

An example of form input defraudation by adding a false form due to cross-site scripting vulnerability will be explained with reference to FIG. 14.

In cross-site scripting, illicit operation may be performed such that a malicious script program is mixed in a Web page browsed by the user and executed in the Web browser of the user to defraud a form input by changing a form transmission destination.

A Web server (1a) in FIG. 14 has vulnerability (note that the Web server itself is authentic).
(1) An attacker sends malicious contents to a client computer. This is done by various methods such as advertisement e-mail and an inducement on a Web-based bulletin board system.
(2) The Web browser of the client computer renders the malicious contents.
(3) The client computer sends to the Web server a GET request containing illicit data such as original data of a false external form display script.
(4) The Web server which has received the GET request executes erroneous output processing.
(5) As a result, the Web server sends an HTML document with the malicious script (false external form output script).
(6) The Web browser of the client computer executes the malicious script.
(7) The Web browser of the client computer displays the form sent from the leakage destination site, i.e., the false form together with authentic contents.
(8) The user inputs information in the false form displayed on the Web browser, and performs transmission operation.
(9) In response to transmission operation by the user, the Web browser of the client computer transmits the information input to the false form to the leakage destination site.

As a result, the client computer illicitly transfers the form input information to the leakage destination site.
(10) The leakage destination site (1c) can illicitly acquire information unique to the user.
(11) The leakage destination site can divert, e.g., the acquired information unique to the user.

To prevent this, the second embodiment cuts off HTML documents with malicious scripts in (5) of FIG. 10, (5) of FIG. 11, (5) of FIG. 12, (5) of FIG. 13, and (5) of FIG. 14 by the proxy server interposed between the Web server and the Internet in FIGS. 10, 11, 12, 13, and 14. This can prevent leakage of cookie information or the like.

A more detailed operation example according to the second embodiment will be explained.

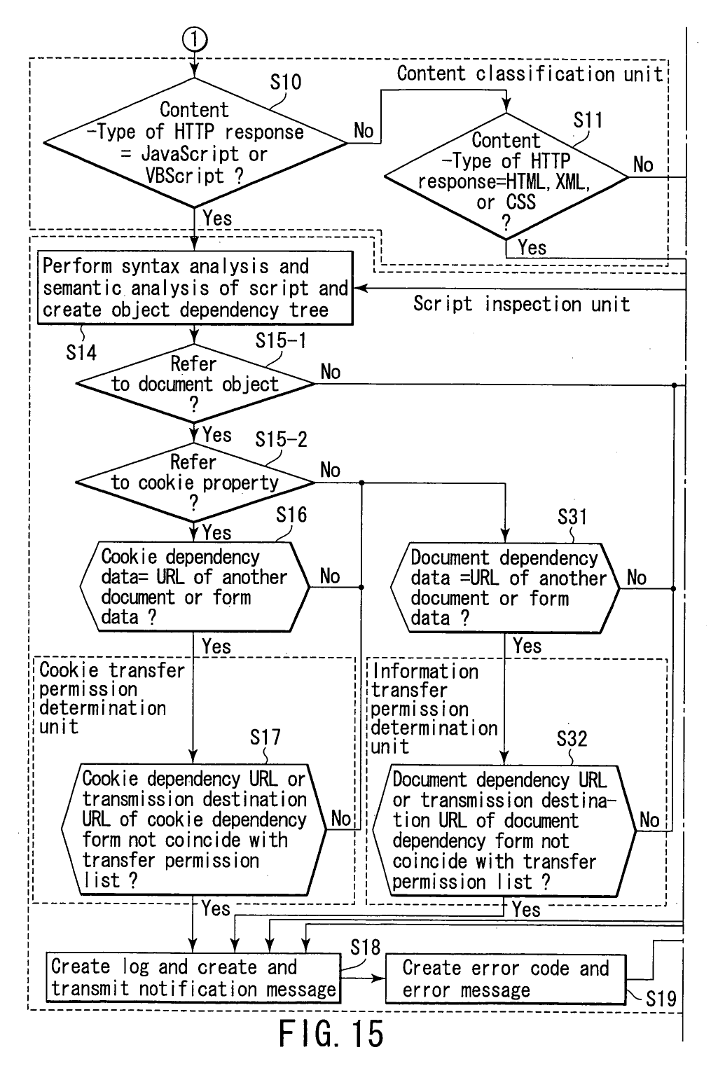

FIGS. 7 and 15 show an example of the processing sequence of the proxy server 3 according to the second embodiment.

For example, JavaScript and VBScript are targeted as scripts, and HTML, XML, and CSS are targeted as documents which may contain scripts. As described above, an example of information stored in a Web browser is a cookie.

Steps S1 to S19 and S22 are basically the same as those described in the first embodiment (see FIGS. 7 and 8).

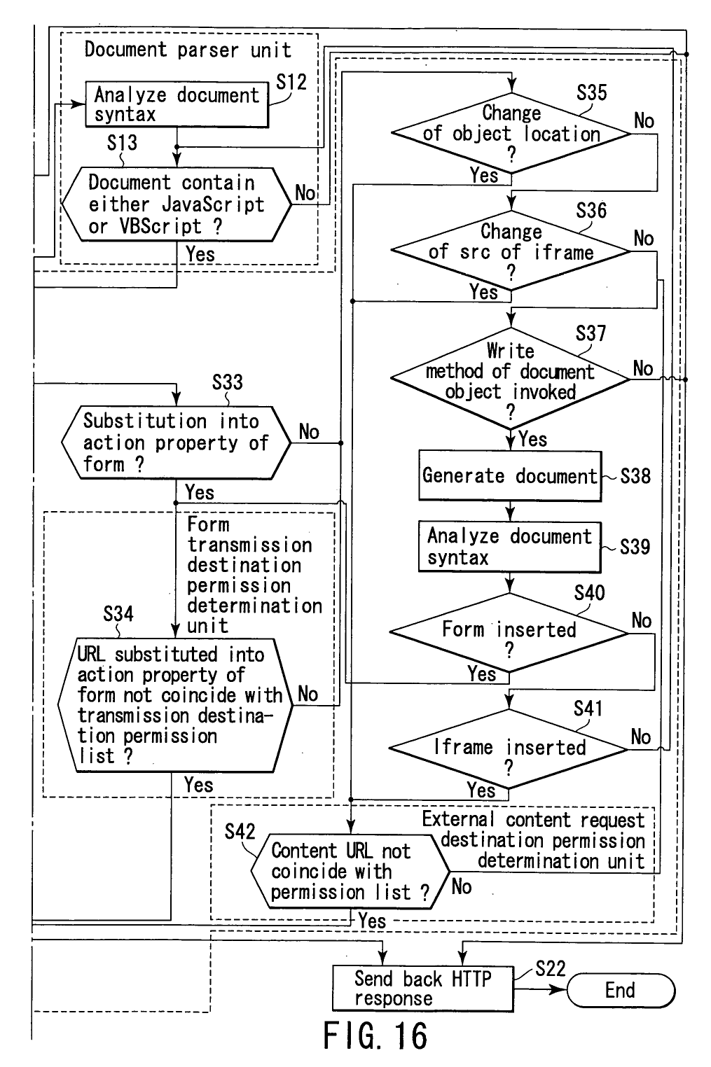

In step S14 of FIG. 8, the script inspection unit 35 executes syntax analysis and semantic analysis of a script. After an object dependency tree to be processed in the script is created, the flow advances to step S20 if no Cookie property of the Document object is referred to in the dependency tree in step S15. In FIGS. 15 and 16, this processing is changed as follows. After step S14, the flow advances to step S15-2 if the Document object is referred to in the dependency tree in step S15-1, step S33 if no Document object is referred to, step S16 if the Cookie property is referred to, and step S31 if no Cookie property is referred to.

In a case in which the Document object is referred to (NO in step S15-2, S16, or S17), if the Document object contains the URLs of other contents or form data (step S31), the script inspection unit 35 causes the transfer permission determination unit 352 to inspect whether the URLs or form data coincide with the contents of the transfer permission list 3521 (step S32). Constant folding processing for the object dependency tree and processing when transfer which is not permitted is determined to be contained are the same as those for cookie inspection (steps S18, S19, and S22). If NO in step S31 or S32, the flow advances to step S33.

In a case in which NO in step S15-2, S31, or S32, if substitution or change of the action property of the form has been done (step S33), the script inspection unit 35 causes the transmission destination permission determination unit 353 to inspect whether these URLs coincide with the contents of the transmission destination permission list 3531 (step S34). Constant folding processing and processing when transfer which is not permitted is determined to be contained are the same as those for cookie inspection (steps S18, S19, and S22). If NO in step S33 or S34, the flow advances to step S35.

In a case in which NO in step S33 or S34, if the local property of the object has been changed (step S35) and the src property of the iframe has been changed (step S36), the script inspection unit 35 causes the request destination permission determination unit 354 to inspect whether these URLs coincide with the contents of the request destination permission list 3541 (step S42). Constant folding processing and processing when transfer which is not permitted is determined to be contained are the same as those for cookie inspection (steps S18, S19, and S22).

In a case in which NO in steps S35 and S36 or NO in step S42, the script inspection unit 35 inspects whether the write method of the Document object has been invoked (step S37). A document to be interpreted by the Web browser is generated by the write method of the Document object. Thus, if the document contains a tag for displaying external contents, this leads to display of a false form. If the document contains a script, the script may be executed. More specifically, if the write method of the Document object has been invoked (step S37), a new document is created by partially executing the script (step S38), and syntax analysis corresponding to the document type is performed (step S39). If a form is generated (step S40), the flow advances to step S34 to perform inspection by the form transmission destination determination unit 353; if an iframe is generated (step S41), the flow advances to step S42 to perform inspection by the external content request destination permission determination unit 354; otherwise (NO in step S41), the script inspection unit 35 hands over processing to the document parser unit 34, and returns to the step (step S13) of inspecting whether a script is contained. If NO in step S37, an HTTP response from the Web server 1 is sent back so as to directly transfer it to the Web browser (step S22).

When the script can be determined through the above inspection not to perform illicit information leakage, an HTTP response from the Web server is sent back so as to directly transfer it to the Web browser.

In this fashion, the second embodiment can prevent leakage of secret information.

In the above description, when transfer of Web contents is determined not to be permitted, sending of the Web contents to the Web browser (client computer 2) is inhibited, and a notification message and error message are transmitted. Alternatively, either or both of transmission of a notification message and transmission of an error message may not be performed (log may not be saved).

In the above description, when the transfer permission determination unit 351, transfer destination determination unit 352, transmission destination determination unit 353, and request destination determination unit 354 use, as a transfer permission rule, the transfer permission list 3511 which holds a list of transfer destinations as URLs, and collate a script with the transfer permission list 3511, the transfer permission list 3521 which holds a list of transfer destinations as URLs, the transmission destination permission list 3531 which holds a list of transmission destinations as URLs, and the request destination permission list 3541 which holds a list of request destinations as URLs have been exemplified. Instead, permitted URLs may be held as the description of regular expressions, the regular expressions may be collated with respective URLs, and only when all the URLs coincide with the regular expressions, a permission result may be sent back. Alternatively, these two methods may be adopted.

The second embodiment comprises all the cookie transfer permission determination unit 351, information transfer permission determination unit 352, form transmission destination permission determination unit 353, and external content request destination permission determination mechanism 354. The first embodiment comprises only the cookie transfer permission determination unit 351. Only one of the information transfer permission determination unit 352, form transmission destination permission determination unit 353, and external content request destination permission determination mechanism 354 may be adopted. Also, any two or three of the cookie transfer permission determination unit 351, information transfer permission determination unit 352, form transmission destination permission determination unit 353, and external content request destination permission determination mechanism 354 may be adopted.

In the first or second embodiment or various embodiments described above, the proxy server (communication gateway apparatus) may be comprised of one apparatus (e.g., a computer) or a plurality of apparatuses (e.g., computers).

In the latter case, only the transfer permission determination unit may be separated from computers which include the proxy server, and formed by another computer. In this case, the computer serving as the proxy server main body and the computer serving as the permission determination unit may be connected via, e.g., a dedicated line or the Internet (in the latter case, security is preferably ensured by encrypted communication or the like).

In the above case, as for the correspondence between the computer serving as the proxy server main body and the computer serving as the permission determination unit, the computer serving as one permission determination unit can be used by the computer serving as one proxy server main body or computers serving as a plurality of proxy server main bodies.

In various embodiments described above, the proxy server (communication gateway apparatus) and Web server are comprised of separate apparatuses (e.g., computers). For example, part of the proxy server (communication gateway apparatus) that corresponds to a function of cutting off malicious contents (e.g., a function of generating and transmitting an error message and notification message out of the functions of the content classification unit 33, document parser unit 34, script inspection unit 35, and network side communication interface 31 in FIGS. 2 and 9) can also be implemented as a function expansion module contained in the Web server. Also in this case, the Web server main body and transfer permission determination unit can be implemented by separate computers.

In various embodiments described above, the Internet has been exemplified as a network. The present invention can also be applied to another network.

In various embodiments described above, JavaScript and VBScript are targeted as scripts, and HTML, XML, and CSS are targeted as documents which may contain scripts. A target script can be selected on the basis of a proper criterion such as a script used in the network or a script which may be illicitly used. This also applies to a document which may contain a script. When a new script or a new document which may contain a script is generated, such script or document suffices to be newly added as a target.

Embodiments of the present invention can prevent transfer of a malicious script which tries to transfer information stored in a client, from the server to the client. This can prevent the malicious script from leaking information stored in the client. As a result, security damage which is responsible for, e.g., the Web server hosting company can be prevented. For example, the Web server administrator can be notified of details of an HTTP session containing a script whose transmission is prevented. Measures such as modification and upgrading can be easily taken for a Web application and middleware suffering cross-site scripting vulnerability.

When a script which tries to transfer content information (e.g., a character string in a Web page), a script which tries to change the transmission destination of an input form in contents (e.g., the action attribute of a form tag in an HTML format), a script which requests another content and displays it instead of the current content, or a script which requests another content and expresses it together with the current content (e.g., displays an iframe tag having the URL of another content as an src attribute in an HTML format) is determined to be contained, the transfer destination of content information, a transmission destination after changing the form, or the request destination of another content is collated with a corresponding access control list. When the destination is a transfer destination which is not permitted (e.g., a transfer destination not contained in the list), transmission of contents to the client is inhibited.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A communication gateway apparatus to be coupled between a server and a client, comprising:
a reception unit configured to receive a content transferred from the server to the client;
an extraction unit configured to extract a script program from the received content;
a storage to store transfer destination information representing a plurality of transfer destinations designated as authentic;
an inspection unit configured to inspect the script program to detect that the script program has a function of transferring any one of information stored in the client and the received content, thereby identifying at least one transfer destination of the information;
a determination unit configured to determine whether or not transfer of the content is permitted, by collating the identified transfer destination of the information with the plurality of transfer destinations of the destination information; and
a transmission unit configured to transmit the content to the client only when the determination unit determines that transfer is permitted.

2. The apparatus according to claim 1, wherein the inspection unit identifies a plurality of transfer destinations of the information, and wherein the determination unit determines that transfer is permitted only if all the transfer destinations of the information are within the plurality of transfer destinations of the destination information.

3. The apparatus according to claim 1, wherein the inspection unit is further configured to output, if the transfer destination of the information is unidentifiable, an arbitrary transfer destination, and the determination unit determines that transfer of the content is not permitted.

4. The apparatus according to claim 1, wherein the information includes cookie information held in a Web browser running in the client.

5. The apparatus according to claim 1, wherein the destination information includes any one of a list of permitted URLs and regular expressions.

6. A communication gateway apparatus to be coupled between a server and a client, comprising:
a reception unit configured to receive a content having an input form and transferred from the server to the client;
an extraction unit configured to extract a script program from the received content;
a storage to store transfer destination information representing a plurality of transfer destinations designated as authentic;
an inspection unit configured to inspect the script program to detect that the script program has a function of changing a transmission destination of the input form, thereby identifying at least one changed transfer destination of the input form;
a determination unit configured to determine whether or not transfer of the content is permitted, by collating the changed transfer destination of the input form with the plurality of transfer destinations of the destination information; and
a transmission unit configured to transmit the content to the client only when the determination unit determines that transfer is permitted.

7. The apparatus according to claim 6, wherein the inspection unit identifies a plurality of changed transfer destinations of the input form, and wherein the determination unit determines that transfer is permitted only if all the changed transfer destinations of the input form are within the plurality of transfer destinations of the destination information.

8. The apparatus according to claim 6, wherein the inspection unit is further configured to output, if the changed transfer destination of the input form is unidentifiable, an arbitrary transfer destination, and the determination unit determines that transfer of the content is not permitted.

9. The apparatus according to claim 6, wherein the destination information includes any one of a list of permitted URLs and regular expressions.

10. A communication gateway apparatus to be coupled between a server and a client, comprising:
a reception unit configured to receive a content having a first input form and transferred from the server to the client;
an extraction unit configured to extract a script program from the received content;
a storage to store request destination information representing a plurality of request destinations designated as authentic;
an inspection unit configured to inspect the script program to detect that the script program has a function of requesting an external content having a second input form to be used in place of the first input form, thereby identifying at least one request destination of the external content;
a determination unit configured to determine whether or not transfer of the content is permitted, by collating the identified request destination of the external content with the plurality of the request destinations of the destination information; and
a transmission unit configured to transmit the content to the client only when the determination unit determines that transfer is permitted.

11. The apparatus according to claim 10, wherein the inspection unit identifies a plurality of request destinations of the external content, and wherein the determination unit determines that transfer is permitted only if all the request destinations of the external content are within the plurality of request destinations of the destination information.

12. The apparatus according to claim 10, wherein the inspection unit is further configured to output, if the request destination of the external content is unidentifiable, an arbitrary request destination, and the determination unit determines that transfer of the content is not permitted.

13. The apparatus according to claim 10, wherein the destination information includes any one of a list of permitted URLs and regular expressions.

14. A communication gateway apparatus to be coupled between a server and a client, comprising:
a reception unit configured to receive a content having a form and transferred from the server to the client;
an extraction unit configured to extract a script program from the received content;
a storage to store request destination information representing a plurality of request destinations designated as authentic;
an inspection unit configured to inspect the script program to detect that the script program has a function of requesting an external content having an input form to be inserted within the form, thereby identifying at least one request destination of the external content;
a determination unit configured to determine whether or not transfer of the content is permitted, by collating the identified request destination of the external content with the plurality of the request destinations of the destination information; and
a transmission unit configured to transmit the content to the client only when the determination unit determines that transfer is permitted.

15. The apparatus according to claim 14, wherein the inspection unit identifies a plurality of request destinations of the external content, and wherein the determination unit determines that transfer is permitted only if all the request destinations of the external content are within the plurality of request destinations of the destination information.

16. The apparatus according to claim 14, wherein the inspection unit is further configured to output, if the request destination of the external content is unidentifiable, an arbitrary request destination, and the determination unit determines that transfer of the content is not permitted.

17. The apparatus according to claim 14, wherein the destination information includes any one of a list of permitted URLs and regular expressions.

18. A communication gateway apparatus to be coupled between a server and a client, comprising:
a reception unit configured to receive a content transferred from the server to the client;
an extraction unit configured to extract a script program from the received content;
a storage to store transfer destination information representing a plurality of transfer destinations designated as authentic;
an inspection unit configured to inspect the script program to detect that the script program has a function of adding an input form to the received content, and a function of transferring the input form, thereby identifying at least one transfer destination of the input form;
a determination unit configured to determine whether or not transfer of the content is permitted, by collating the identified transfer destination of the information with the plurality of transfer destinations of the destination information; and
a transmission unit configured to transmit the content to the client only when the determination unit determines that transfer is permitted.

19. The apparatus according to claim 18, wherein the inspection unit identifies a plurality of transfer destinations of the input form, and wherein the determination unit determines that transfer is permitted only if all the transfer destinations of the information are within the plurality of transfer destinations of the destination information.

20. The apparatus according to claim 18, wherein the inspection unit is further configured to output, if the transfer destination of the information is unidentifiable, an arbitrary transfer destination, and the determination unit determines that transfer of the content is not permitted.

21. The apparatus according to claim 18, wherein the destination information includes any one of a list of permitted URLs and regular expressions.

22. The apparatus according to claim 1, further comprising:
a document generation unit configured to generate a document by partially executing the extracted script program, and wherein the extraction unit further extracts another script program to be inspected from the document.

23. The apparatus according to claim 1, wherein when the determination unit determines that transfer is not permitted, the transmission unit transmits an error content to the client instead of the received content.

24. The apparatus according to claim 1, wherein when the determination unit determines that transfer is not permitted, the transmission unit transmits a message notifying that transfer is not permitted, to an account of an administrator.

25. The apparatus according to claim 24, wherein the transmission unit adds at least the received content to the message and transmits the message.

26. A method of affording security of communication between a vulnerable server and a client, comprising:
receiving a content transferred from the vulnerable server;
extracting a script program from the received content;
inspecting the script program to identify a transfer destination of information, where transferring the information is caused by the client executing the script program;
collating the identified transfer destination of the information with a permitted transfer destination list; and
transmitting the received content to the client only if the identified transfer destination of the information is within the permitted transfer destination list, so as to prevent the information from illicitly transferring to a malicious server.

27. A computer program product for affording security of communication between a vulnerable server and a client, comprising:
means for instructing a computer to receive a content transferred from the vulnerable server;
means for instructing the computer to extract a script program from the received content;
means for instructing the computer to inspect the script program to identify a transfer destination of information, where transferring the information is caused by the client executing the script program;
means for instructing the computer to collate the identified transfer destination of the information with a permitted transfer destination list; and
means for instructing the computer to transmit the received content to the client only if the identified transfer destination of the information is within the permitted transfer destination list, so as to prevent the information from illicitly transferring to a malicious server.
